(19) United States
(12) Patent Application Publication
(10) Pub. No.: US 2015/0161937 A1
(43) Pub. Date: Jun. 11, 2015

(54) OVERLAPPING DETECTION DISPLAY AND METHOD

(71) Applicant: Lenovo (Singapore) Pte. Ltd., Singapore (SG)

(72) Inventors: Howard J. Locker, Cary, NC (US); Elif Karakaya, Raleigh, NC (US); Matthew Lloyd Hagenbuch, Durham, NC (US); Matthew Price Roper, Raleigh, NC (US)

(73) Assignee: Lenovo (Singapore) Pte. Ltd., Singapore (SG)

(21) Appl. No.: 14/098,127

(22) Filed: Dec. 5, 2013

(51) Int. Cl. G09G 3/20; G06F 3/14

(52) U.S. Cl. CPC G09G 3/2096; G06F 3/1446; G09G 2300/026; G09G 2370/04; G09G 2356/00; G09G 2340/14

(57) ABSTRACT

A method includes receiving information identifying overlap of multiple overlapping screens of display devices, determining a screen size corresponding to the overlapping screens, determining pixels to display on each overlapping display screen, and sending the determined pixels to each display screen to display images on the display screens corresponding to the determined screen size.

### BACKGROUND

Lightweight displays are getting thinner and thinner, and can be easily arranged in arrays, forming large virtual displays. Sometimes, the amount of space available to arrange the displays may not be sufficient to provide for an edge to edge placement of the displays. Tables on which such displays may be arranged come in various sizes. For example, an airplane tray may not be large enough to hold an entire array of displayed arranged edge to edge.

A screen resolution application in Windows®, allows displays to be configured as arrays, so that the image on one display extends to the adjacent display. However, such applications assume that the displays are arranged edge to edge.

### SUMMARY

A method includes receiving information identifying overlap of multiple overlapping screens of display devices, determining a screen size corresponding to the overlapping screens, determining pixels to display on each overlapping display screen, and sending the determined pixels to each display screen to display images on the display screens corresponding to the determined screen size.

A device including a display screen having a plurality of sensors positioned about the display screen to detect an amount of overlap of the display screen by another device. A communication device is coupled to the display screen and the sensors. The communication device is adapted to send information corresponding to the detected amount of overlap and to receive pixels to display on a non-overlapped portion of the display screen.

A system includes communication device to receive information identifying overlap of multiple overlapping screens of display devices, a processor coupled to the communication device and programmed to determine a screen size corresponding to the overlapping screens, the processor further programmed to determine pixels to display on each overlapping display screen, and the communication device sending the determined pixels to each display screen to display images on the display screens corresponding to the determined screen size.

### BRIEF DESCRIPTION OF THE DRAWINGS

FIG. 1 is a block diagram of a system for driving overlapping displays according to an example embodiment.

FIGS. 2A, 2B, and 2C are block diagram representations of overlapping displays according to an example embodiment.

FIG. 3 is a block diagram a different pattern of overlapping displays according to an example embodiment.

FIG. 4 is a flowchart illustration of a method of driving overlapping displays according to an example embodiment.

FIG. 5 is a flowchart illustration of a method of identifying a correct arrangement of displays in an array of overlapping displays according to an example embodiment.

FIG. 6 is a block diagram of a display device for detecting overlapping according to an example embodiment.

FIG. 7 is a block diagram of a computer system for driving overlapping displays according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

In various embodiments, an overlay pattern of an array of display screens is determined. Each screen in one embodiment may be touch enabled or otherwise contain sensors and can detect exactly what part of the screen is exposed and what part of the screen has something such as another screen on top of it.

Each of the screens report the overlay versus exposed portions and the information may be provided to a common graphics controller via any wireless protocol. Once the screens' exposed vs. covered areas are known it is very easy for the graphics controller to determine an available screen total size and send the correct pixel information to each of the displays to provide a unified desktop view. In some embodiments, parts of each screen that are covered may be powered off to save power.

Once the available screen total size is determined, normal video controls/gestures work on the displays similar to if the displays were a physical single display. As an example the user can pinch and zoom, scroll in any direction, etc. across the displays as if they were one display. While several embodiments are shown with four rectangular displays having various overlap arrangements, fewer or more displays may be included, and non-rectangular shapes may also be accommodated.

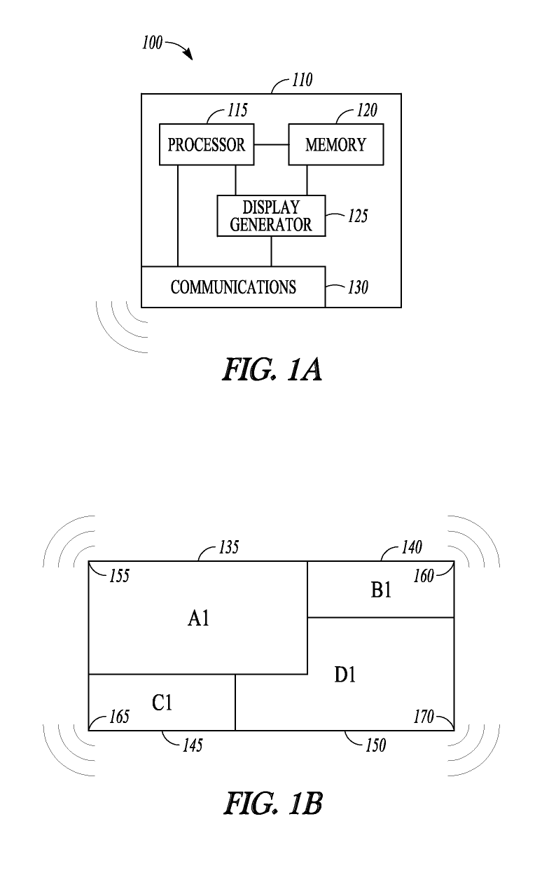

FIG. 1 is a block diagram of a system 100 for identifying screen overlap and providing pixels to the displays to utilize an available area on the screens determined from the overlap. System 100 in one embodiment includes a computer system 110, such as a laptop computer, desktop computer, touchpad, smart phone, or other device that includes a processor 115 and memory 120 coupled to the processor driving the screens to provide a desktop. Memory 120 may include programming to cause the processor 115 to perform methods for various embodiments. A display generator 125 may be coupled to the processor 115 and optionally to the memory 120 to generate sets of pixels for each display to display on corresponding screens to provide a look of a single display. The processor and display generator may be coupled to communications device 130, which may include wireless communications.

Multiple displays, A1 at 135, B1 at 140, C1 at 145, and D1 at 150 are shown as overlapping. Each display in one embodiment contains corresponding wireless communications capabilities as represented at 155, 160, 165, and 170 respectively.

Display A1 at 130 is not overlapped by any other display device, and reports the same back to computer system 110. Display B1 at 140 is overlapped by display D1 at 170 and A1 at 135, and reports this information. Display D1 at 170 is only overlapped by Display A1 at 135 and reports this information. Display C1 at 145 is overlapped by both displays A1 at 135 and D1 at 150, and reports this information. The information received by computer system 110 may be pieced together like a jigsaw puzzle such that the computer system 110 knows how to piece the uncovered areas of the displays into the pattern shown in FIG. 1, and hence which pixels of a desktop image to send to each display for display of a continuous image across an available display size.

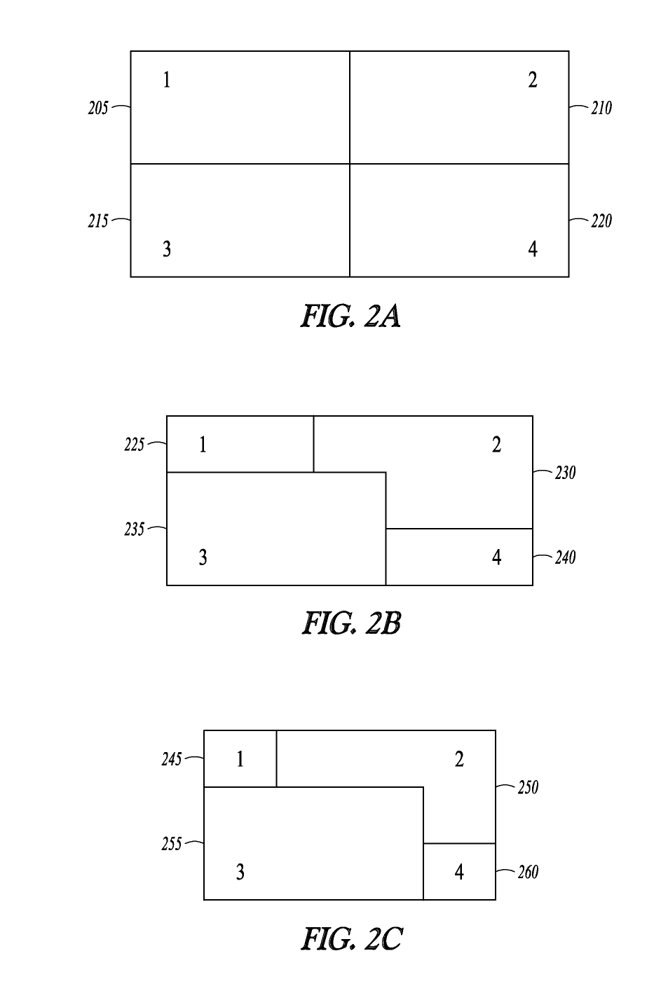

FIGS. 2A, 2B, and 2C illustrate various patterns of overlapping display screens. Display screens 205, 210, 215, and 220 are shown in FIG. 2A, with no overlap. Thus each display screen detects that none of the screens are covered by other screens. The computer system will drive each display as though the array of displays was placed side to side with no overlap. This orientation provides a largest available screen size for an array of four displays.

FIG. 2B illustrates an array of overlapping displays 225, 230, 235, and 240. Screen 235 reports that it has no overlapped portions, and all of it is available for display. Screen 230 is only overlapped by screen 235. Screens 225 and 240 are both overlapped by screens 235 and 230. FIG. 2C provides yet a smaller available total screen size, and has an overlap pattern of screens 245, 250, 255 and 260 as in FIG. 2B, but with more of the respective overlapped areas.

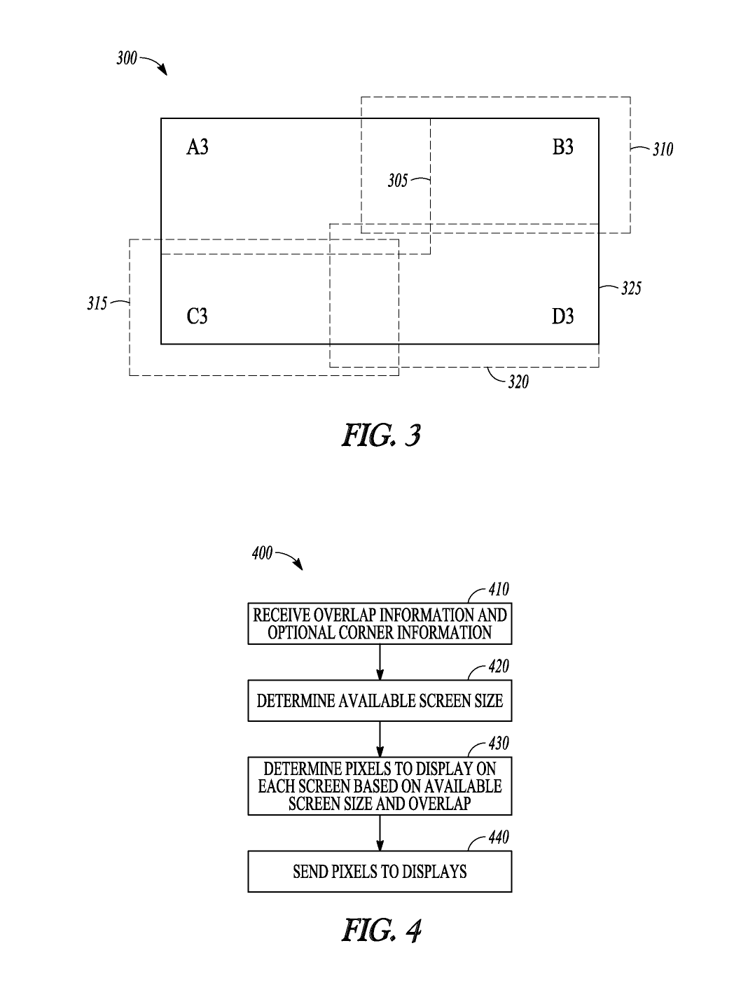

FIG. 3 illustrates an alternative array four displays at 300. Screens A3 at 305, B3 at 310, C3 at 315, and D3 at 320 are shown in a non rectangular array shape, and are shown in broken line form, with an available area calculated by computer system 110 shown by solid line 325. Solid line 325 illustrates a standard screen size for showing a desktop. Note that there are several areas of uncovered screens that may not be utilized for display in order to limit the available size to a maximum size corresponding to a supported aspect ratio. In further embodiments, the available area 325 may be extended down to the bottom of screen 320. While this may not be a standard aspect ratio, some graphics cards corresponding to display generator 125 may be able to provide pixels to fill such an area.

FIG. 4 is a flow chart illustration of a method 400 for utilizing an available area determined from screen overlapping information from an array of display screens. At 410, information identifying overlap of multiple overlapping screens of display devices is received. At 420, a screen size corresponding to the overlapping screens is determined. At 430, pixels to display on each overlapping display screen is determined. The determination may be based on available screen size and overlap. At 440, the determined pixels are sent to each display screen to display images on the display screens corresponding to the determined screen size.

In one embodiment, the determined screen size is rectangular in shape. The determined screen size may include a screen that is not overlapped, and may also extend to screens that are overlapped to form a largest possible rectangular screen shape. In still further embodiments, the determined screen size need not be rectangular, and may simply extend to all uncovered areas of the displays, or be some other desired shape, such as circular or triangular.

In a further embodiment, the information identifying overlap of multiple overlapping screens of display devices may be received from the display devices. The information identifying overlap of multiple overlapping screens may be performed by capacitive sensing, light sensors, magnetic sensors, or other means of identifying screen overlap. The capacitive sensing may be performed utilizing the conductive traces used to determine gestures in touch screens in one embodiment.

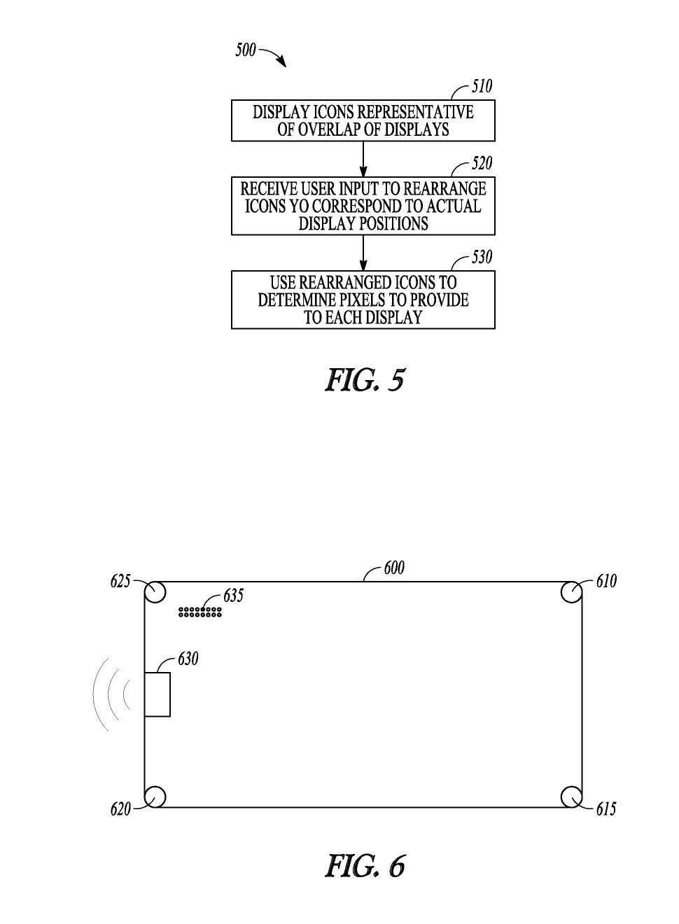

In still further embodiments, determining a screen size includes determining relative positions of each screen with respect to other screens to avoid errors in identifying relative locations of screens in the array with respect to other screens. Such a determination may be made as illustrated in flowchart form in FIG. 5 at a method 500 by providing an interactive display of screen icons on a screen at 510 that is not covered by other screens such that the screen icons are moveable by a user to correct incorrectly determined relative positions. At 520 user input may be received to rearrange the icons to correspond to actual display positions. At 530, the rearranged icons may be used to determine pixels to provide to each display.

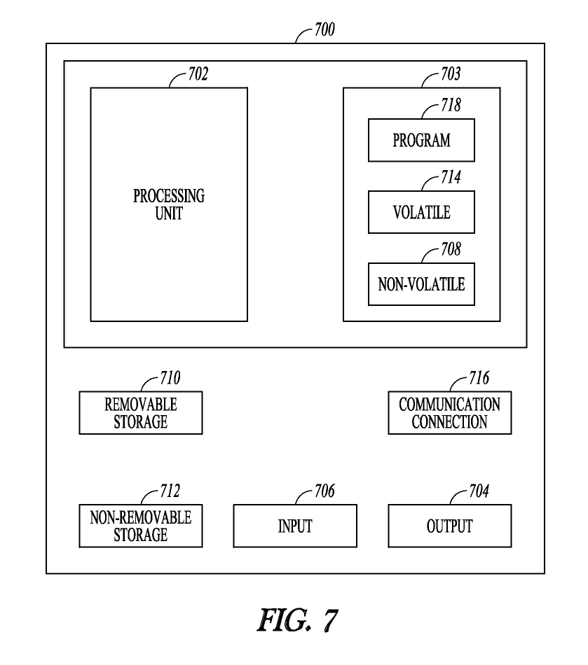

FIG. 6 is a block diagram illustrating a display screen device 600. Sensors may be located on each corner of display screen as shown at 610, 615, 620, and 625 to provide information identifying corners of each screen relative to other screens. Such sensors may utilize near field communication devices arranged on corners of the displays, and provide an identification of each display and relative corner so that nearby displays may use the information and communicate it back to the computer system 110 to aid in determining relative placement of the displays in addition to the information identifying covered and not covered areas of each display.

FIG. 6 also illustrates a portion of sensors 635 which may be used to detect overlap of the screen. Only a small area is shown, and such sensors may be light sensors, capacitive sensors, magnetic sensors, or any other type of sensor capable of detecting overlap of screens with accuracy sufficient to utilize for driving the array of displays such that a nearly seamless composite image is provided. In further embodiments, the image need not be nearly seamless, but should align reasonably closely to be acceptable to users.

FIG. 7 is a block schematic diagram of a computer system 700 to implement one or more embodiments. One example computing device in the form of a computer 700, may include a processing unit 702, memory 703, removable storage 710, and non-removable storage 712. Memory 703 may include volatile memory 714 and non-volatile memory 708. Computer 700 may include—or have access to a computing environment that includes—a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 700 may include or have access to a computing environment that includes input 706, output 704, and a communication connection 716. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 702 of the computer 700. A hard drive, CD-ROM, and RAM are some examples of articles including a non-transitory computer-readable medium. For example, a computer program 718 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 700 to provide generic access controls in a COM based computer network system having multiple users and servers.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
receiving information identifying overlap of multiple overlapping screens of display devices;
determining a screen size corresponding to the overlapping screens;
determining pixels to display on each overlapping display screen; and
sending the determined pixels to each display screen to display images on the display screens corresponding to the determined screen size.

2. The method of claim 1 wherein the determined screen size is rectangular in shape.

3. The method of claim 2 wherein the determined screen size includes a screen that is not overlapped, and extends to screens that are overlapped to form a largest possible rectangular screen shape.

4. The method of claim 1 wherein the information identifying overlap of multiple overlapping screens of display devices is received from the display devices.

5. The method of claim 4 wherein the information identifying overlap of multiple overlapping screens is performed by capacitive sensing.

6. The method of claim 4 wherein the information identifying overlap of multiple overlapping screens is performed by light sensing.

7. The method of claim 4 wherein determining a screen size includes determining relative positions of each screen with respect to other screens.

8. The method of claim 7 wherein determining a screen size includes providing an interactive display of screen icons on a screen that is not covered by other screens such that the screen icons are moveable by a user to correct incorrectly determined relative positions.

9. The method of claim 1 and further comprising receiving information identifying corners of each screen relative to other screens.

10. A device comprising:
a display screen;
a plurality of sensors positioned about the display screen to detect an amount of overlap of the display screen by another device;
a communication device coupled to the display screen and the sensors, the communication device adapted to send information corresponding to the detected amount of overlap and to receive pixels to display on a non-overlapped portion of the display screen.

11. The device of claim 10 wherein the sensors comprise capacitive sensors.

12. The device of claim 10 wherein the sensors comprise magnetic sensors.

13. The device of claim 10 and further comprising sensors on each corner of the display screen to detect corners of other display screens.

14. The device of claim 10 and further comprising multiple additional display screens positionable to overlap, each display screen including:
a plurality of sensors positioned about the display screen to detect an amount of overlap of the display screen by another device;
a communication device coupled to the display screen and the sensors, the communication device adapted to send information corresponding to the detected amount of overlap and to receive pixels to display on a non-overlapped portion of the display screen, and wherein the pixels sent to the multiple overlapping display screens form a rectangular display area.

15. A system comprising:
a communication device to receive information identifying overlap of multiple overlapping screens of display devices;
a processor coupled to the communication device and programmed to determine a screen size corresponding to the overlapping screens;
the processor further programmed to determine pixels to display on each overlapping display screen; and
the communication device sending the determined pixels to each display screen to display images on the display screens corresponding to the determined screen size.

16. The system of claim 15 wherein the determined screen size is rectangular in shape, and wherein the determined screen size includes a screen that is not overlapped, and extends to screens that are overlapped to form a largest possible rectangular screen shape.

17. The system of claim 15 wherein the information identifying overlap of multiple overlapping screens of display devices is received from the display devices, and wherein the information identifying overlap of multiple overlapping screens is performed by capacitive sensing.

18. The system of claim 17 wherein determining a screen size includes determining relative positions of each screen with respect to other screens.

19. The system of claim 18 wherein determining a screen size includes providing an interactive display of screen icons on a screen that is not covered by other screens such that the screen icons are moveable by a user to correct incorrectly determined relative positions.

20. The system of claim 15 wherein the communication device further receives information identifying corners of each screen relative to other screens.
